(19) United States
(12) Patent Application Publication
(10) Pub. No.: US 2005/0037176 A1
(43) Pub. Date: Feb. 17, 2005

(54) Articles made from wood substrates crosshead extruded with ionomers

(76) Inventor: Joseph Dominic Domine, Humble, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/638,773

(22) Filed: Aug. 11, 2003

(51) Int. Cl. B32B 3/10

(52) U.S. Cl. 428/138; 428/537.1

(57) ABSTRACT

The present invention relates to wood articles made from wood substrates and ionomers, and processes for making the same. In particular, the present invention relates to wood substrates, i.e., natural wood, pressure treated wood, or laminated wood, crosshead extruded with ionomers, to form wood articles.

### FIELD OF THE INVENTION

The present invention relates to wood articles made from wood substrates and ionomers, and processes for making the same. In particular, the present invention relates to wood substrates, i.e., natural wood, pressure treated wood, or laminated wood, crosshead extruded with ionomers, to form wood articles.

### BACKGROUND OF THE INVENTION

Wood is useful for making several types of articles such as play-structures for children, decks, picnic tables, benches, landscaping timbers, fencing, gates, patios, walkways, boat docks, and the like. However, without surface treatments, articles made from wood succumb to the effects of weathering over time. Therefore, in order to mitigate against the effects of weathering, articles made from wood generally require the reapplication of protective surface treatments many times over the life of the articles. As such, there exists a need to provide wood articles that maintain or improve the aesthetics and appearance of wood and yet provide resistance to weathering of wood without reapplication of surface treatments.

One alternative to reapplying surface treatments is disclosed in U.S. Pat. No. 4,181,764 to Totten (herein “Totten”). Totten provides for a rail and a method of manufacture of a rail comprising the steps of selecting an elongated piece of wood, introducing the wood along its longitudinal axis into a crosshead die, the crosshead die being mounted on a plastic extrusion machine, drawing a vacuum on the wood in the die, extruding a thermoplastic resin on the wood forming a protective coating thereon, withdrawing the coated product from the die at a rate sufficient to draw the coating into tight contact with the wooden core, and allowing the coating to cool, the method also including the step of forming a plurality of perforations through the coating. The protective coating is typically formed from a thermoplastic material, such as polyvinyl chloride or polyethylene. However, Totten does not appear to teach the application of ionomer materials using the crosshead extrusion method described above nor does Totten appear to teach articles wherein the underlying wood substrate is visible.

However, in another field, ionomer materials have been applied to some woods employing different fabrication methods to solve different problems. For example, U.S. Pat. No. 4,445,688 to Frillici et al. (herein “Frillici”). Frillici discloses a bowling pin comprising a preformed wood core encased in a plastic cladding comprising a resinous layer composed of an ionomer resin. The bowling pin provides for rugged serviceability and reduced maintenance needs, but requires little if any break-in period before consistent scoreability can be attained. Frillici discloses a general method of manufacturing the bowling pins, i.e., twin sheet rotary thermoforming. (See Frillici Example). Thus, the art has yet to provide for wood articles that maintain or improve the aesthetics and appearance of wood and yet provide resistance to weathering of wood without the reapplication of surface treatments.

Additionally, there exists a need to provide a barrier between certain pressure treated woods and human contact. For example, the lumber industry has been voluntarily moving away from using pressure treated wood containing human carcinogens in the construction of devices that will inevitably come into human contact, i.e., play structures for children, picnic tables, benches, etc. An example of such a carcinogen is arsenic, or, more particularly, a chemical compound mixture containing inorganic arsenic, copper and chromium (CCA). CCA has been used as a wood preservative since the 1940s. CCA is injected into wood by a process that uses high pressure to saturate wood products with chemicals. CCA is intended to protect wood from dry rot, fungi, molds, termites, and other pests that can threaten the integrity of wood products. Despite its usefulness to protect wood, the EPA believes that any reduction in the levels of potential exposure to arsenic is desirable. (Whitman Announces Transition from Consumer Use of Treated Wood Containing Arsenic, EPA Newsroom, Feb. 12, 2002 (www.epa.gov/pesticides/citizens/1file.htm)). Therefore, there also exists a need to provide a barrier between the pressure treated woods as described above and human contact to reduce any potential exposure to chemical compounds used in the production of pressure treated woods.

The invention fulfills these needs by improving the resistance to weathering of wood without the reapplication of protective surface treatments. Additionally, in embodiments including pressure treated woods, the invention also provides for a barrier between pressure treated woods and human contact to reduce the potential exposure of the chemicals contained in pressure treated woods.

### SUMMARY OF THE INVENTION

In one embodiment, the invention provides for a wood article comprising a wood substrate and an ionomer layer.

In one embodiment, the invention provides for a wood article comprising a wood substrate cross head extruded with an ionomer layer.

In another embodiment, the invention provides for a method of forming a wood article comprising the steps of selecting a wood substrate; introducing the wood substrate along its longitudinal axis into a crashed die, the crashed die mounted on a plastic extrusion machine; subjecting said wood substrate to a vacuum; extruding an ionomer layer on the wood substrate; and forming a wood article.

In yet another embodiment, the invention provides for a method to produce a wood article comprising the steps of obtaining a wood substrate and crosshead extruding the wood substrate with an ionomer layer to form the wood article.

In any of the embodiments described in this SECTION (Summary), the ionomer layer may encase the wood substrate.

In any of the embodiments described in this SECTION (Summary), the wood substrate may not comprise maple wood.

In any of the embodiments described in this SECTION (Summary), the wood substrate may comprise natural wood, pressure treated wood, laminated wood, or combinations thereof.

In any of the embodiments described in this SECTION (Summary), the wood substrate may comprise select lumber.

In any of the embodiments described in this SECTION (Summary), the wood substrate may comprise common lumber.

In any of the embodiments described in this SECTION (Summary), the wood substrate may comprise at least one hardwood.

In the previous embodiment, the at least one hardwood may be selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; maple; mahogany; oak; olive; persea; plum; purpleheart; rosewood; sassafras; sidder; sycamore; storax; sweet gum; tamarisk; teak; tulipwood; walnut; willow; popular; and combinations thereof.

In any of the embodiments described in this SECTION (Summary), the wood substrate may comprise at least one softwood.

In the previous embodiment, the at least one softwood may be selected from the group consisting of cedar; cyprus; juniper; savin; hemlock; western; fir; larch; pine; redwood; spruce; yew; and combinations thereof.

In any of the embodiments described in this SECTION (Summary), the wood substrate may comprise a primed wood.

In the previous embodiment, the primed wood may be primed using an aqueous dispersion of an acid containing polymer.

In the previous embodiment, the acid containing polymer may be ethylene (meth)acrylic acid copolymer.

In the previous embodiment, the ethylene (meth)acrylic acid copolymer may comprises from about 10 wt % to about 30 wt % polymer units derived from the acid monomers.

In any of the embodiments described in this SECTION (Summary), the wood substrate may comprise burl wood, face burl wood, wormed wood, blackened wood, or combinations thereof.

In any of the embodiments described in this SECTION (Summary), the ionomer layer may comprises a first ionomer layer and a second ionomer layer.

In the previous embodiment, the first ionomer layer or the second ionomer layer may be pigmented, natural, or clear.

In any of the embodiments described in this SECTION (Summary), the ionomer layer may be transparent.

In any of the embodiments described in this SECTION (Summary), the wood article may further comprise a plurality of valves or perforations.

In any of the embodiments described in this SECTION (Summary), the wood article may have an essentially uniform cross section.

In any of the embodiments described in this SECTION (Summary), the ionomer layer may have a uniform ionomer layer thickness.

In any of the embodiments described in this SECTION (Summary), the ionomer layer may have an ionomer layer thickness of 2.0 mm or less.

Additionally, in any of the previous embodiments, the invention provides for an optional tie-layer.

### BRIEF DESCRIPTION OF DRAWINGS

FIG. 1 is a drawing of a typical bowling pin. FIGS. 1A through 1C are cross sectional views at the locations indicated on the bowling pin (FIG. 1). These cross sectional views show how a bowling pin has the same circular shape at all these locations, but it does not have the same size at all these locations indicated by the different diameters of the cross sections.

FIG. 2 is a drawing of an example of a wood substrate, an elongated piece of wood, with essentially uniform cross section. FIGS. 2A through 2E are cross sectional views at the locations along the length of the elongated piece of wood as indicated on FIG. 2. These cross sectional views show how an elongated piece of wood has the same shape, e.g., rectangular shape, and size at all these locations.

FIG. 3 is a drawing of an elongated piece of wood coated with ionomer. FIGS. 3A through 3E are cross sectional views at the locations along the length of the elongated piece of wood as indicated on FIG. 3. Number 11 points to the ionomer layer on three sides of the wood article as indicated. Number 13 points to the ionomer layer on one side of the wood article and as indicated, is a thicker layer than on the other three sides. These cross sectional views show how the ionomer layer thickness is essentially uniform along the length of the wood article. These cross sectional views also show how the ionomer layer thickness can vary around the perimeter of the of the cross section, thus, allowing for the creation of a thicker, wear layer on one surface and a thinner layer on the other sides of the article.

FIG. 4 is a drawing of an elongated piece of wood with an ionomer surface layer and subsurface tie-layer. FIGS. 4A through 4E are cross sectional views at the locations along the length of the elongated piece of wood as indicated on FIG. 4. Number 15 points to the wood substrate. Number 17 points to the subsurface tie-layer. Number 19 points to the ionomer surface layer. These cross sectional views show that the tie-layer, which may comprise more than one layer, and ionomer layer, which also may comprise more than one layer, are essentially uniform in thickness along the length of the wood article.

### DETAILED DESCRIPTION OF THE INVENTION

As used herein, the term “layer” refers to each of the one or more materials, the same or different that are secured to one another by any appropriate means such as by an inherent tendency of the materials to adhere to one another, or by inducing the materials to adhere as by a heating, radiative, chemical, or some other appropriate process.

As used herein, “wood substrate” refers to an elongated piece of wood, either natural wood, pressure treated wood, or laminated wood(s).

As used herein, “wood article” refers to an article made from a wood substrate with an ionomer layer disposed thereon.

As used herein, the term “tie-layer” refers to one or more layer(s) disposed between the ionomer layer(s) and the wood substrate.

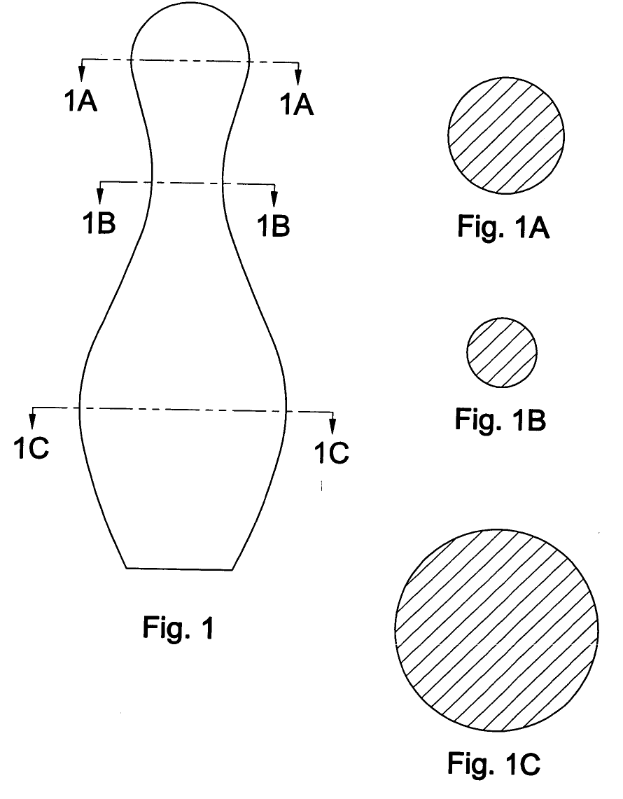

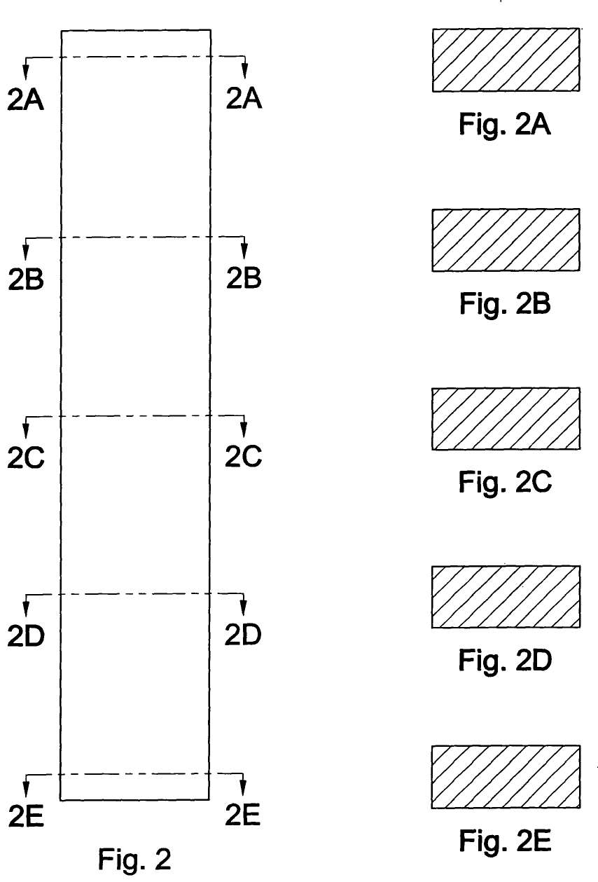

As used herein, the term “essentially uniform cross section” denotes that the cross section, viewed perpendicular to the wood substrate's length, is essentially uniform in both shape and size at any location along the wood substrate's length. For example, the cross section of a bowling pin determined in various locations along its length is essentially the same in shape (circular) but not in size (different diameters). See FIG. 1. In contrast, the cross section of a wood substrate of the present invention is essentially the same in shape (either circular, oval, polygonal, etc.) and in size (perimeter) at various locations along its length. See FIG. 2. In particular, in one embodiment, when the wood substrate is a wooden plank, the cross section of the wooden plank is the same shape (rectangular) and size (perimeter) at all locations along its length. See id. As a result, all cuts, literal or virtual, perpendicular to the long axis of the wood substrate, would yield essentially identical cut faces.

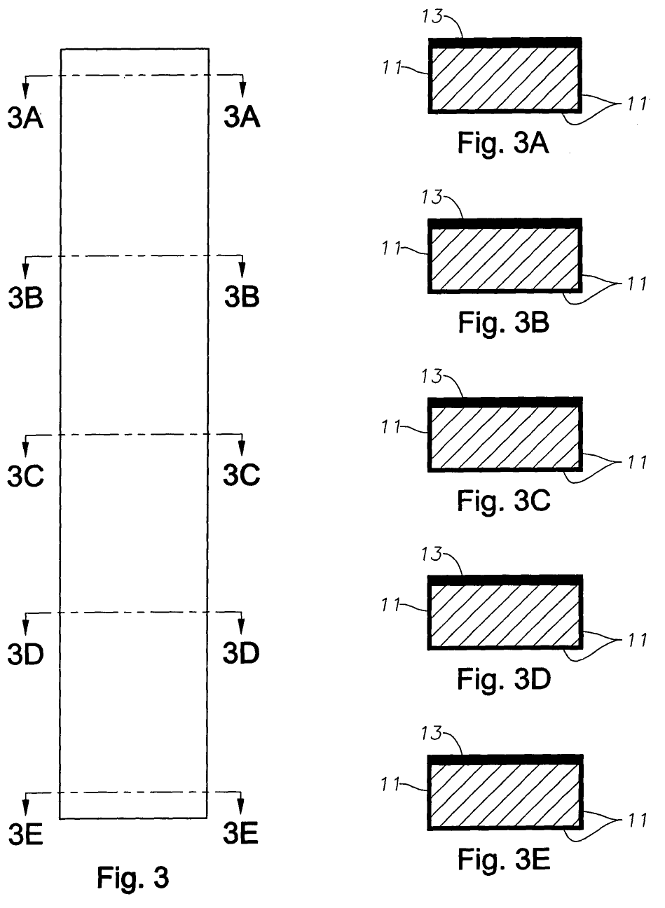

As used herein, the term “uniform ionomer layer thickness” implies that the thickness of the ionomer layer or layers, including any optional tie-layer(s) present, measured at any location on the perimeter of the cross section of the wood article, is essentially uniform along the length of the wood article. However, the thickness of the ionomer layer does need to be uniform at all locations along the perimeter of the cross section of the wood article. For example, in an embodiment producing a wood article (a plank) for use in making a deck, the ionomer thickness on the wear surface may be greater than the ionomer thickness of any of the other surfaces, but still essentially uniform along the length the plank. See FIG. 3.

As used herein, “(meth)acrylate” refers to either methacrylate or acrylate esters and “(meth)acrylic acid” refers to either methacrylic acid or acrylic acid.

As used herein, “polar copolymer” implies a copolymer of one or more C₂-C₁₀ α-olefins copolymerized with one or more polar monomers selected from the group consisting of ethylenically copolymerizable C₃-C₂₃ acidic monomers; ethylenically copolymerizable C₄-C₃₃ esters of acidic monomers; C₄-C₃₃ anhydrides of diacid monomers; C₆-C₃₃ epoxy-containing monomers; and C₃-C₂₃ vinyl ester monomers.

As used herein, “hydrocarbon” refers to molecules or segments of molecules containing primarily hydrogen and carbon atoms. “Hydrocarbon” also includes halogenated versions and versions containing heteroatoms.

As used herein, the term “Groups” or “Group” refers to the new numbering scheme for the Periodic Table Groups as in HAWLEY'S CONDENSED CHEMICAL DICTIONARY 852 (13th ed. 1997).

In one embodiment, melted ionomer is applied to the longitudinal surfaces of an elongated piece of wood using a crosshead extruder.

In another embodiment, a tie-layer is used in conjunction with an ionomer surface layer.

In another embodiment, a tie-layer is coextruded with an ionomer surface layer onto the longitudinal surfaces of an elongated piece of wood using a crosshead coextrusion process.

In another embodiment, a tie-layer and an ionomer layer are applied in separate operations to the longitudinal surfaces of an elongated piece of wood using at least one crosshead extruder.

In any of the structures described above, the tie-layer preferably comprises a copolymer of a C₂ to C₁₀ alpha-olefin copolymerized with an alkyl (meth)acrylate.

In any of the structures described above, the tie-layer preferably comprises a terpolymer of a C₂ to C₁₀ alpha-olefin copolymerized with an alkyl (meth)acrylate and an acidic monomer such as (meth)acrylic acid.

In any of the structures described above, the tie-layer preferably comprises an epoxy containing polymer such as ethylene glycidyl methacrylate copolymers and terpolymers wherein the additional monomer is selected from the group consisting of methyl (meth)acrylate, ethyl (meth)acrylate, propyl (meth)acrylate, and butyl (meth)acrylate.

In any of the structures described above, the tie-layer preferably comprises ethylene (meth)acrylic acid copolymers alone or in blends with polyolefins and/or acid terpolymers.

In any of the structures described above, the tie-layer preferably comprises ethylene alkyl(meth)acrylate ester copolymers, more preferably wherein the alkyl(meth)acrylate monomer is selected from the group consisting of methyl (meth)acrylate, ethyl (meth)acrylate, propyl (meth)acrylate, butyl (meth)acrylate, and blends thereof. The ethylene alkyl(meth)acrylate ester copolymer may be used alone or in blends with polyolefins and/or acid copolymers or terpolymers.

In any of the structures described above, the tie-layer preferably comprises ethylene alkyl(meth)acrylate ester (meth)acrylic acid terpolymers, more preferably wherein the alkyl(meth)acrylate monomer is selected from the group consisting of methyl (meth)acrylate, ethyl (meth)acrylate, propyl (meth)acrylate, butyl (meth)acrylate, and blends thereof and the (meth)acrylic acid is acrylic acid, methacrylic acid or blends thereof. The ethylene alkyl(meth)acrylate ester (meth)acrylic acid terpolymer may be used alone or in blends with polyolefins and/or acid copolymers.

In another embodiment, the wood substrate is primed using materials well known in the art for priming wood or other cellulosic materials, prior to having ionomer applied via crosshead extrusion.

In another embodiment, the primer used on the wood substrate is an aqueous dispersion of an acid containing polymer such as ethylene (meth)acrylic acid containing from about 10 wt % to about 30 wt % of the polymer derived from acid monomers.

In another embodiment, the wood substrate is pretreated with flame prior to having ionomer applied to it by crosshead extrusion.

In another embodiment, the wood substrate is preheated with flame and/or hot air prior to having ionomer applied to it by crosshead extrusion.

Ionomer

Ionomers useful in the present invention are ionic compounds which are copolymers of C₂ to C₄ α-olefin derived units (ethylene is herein included as an “α-olefin”), and ethylenically copolymerizable acidic monomers including C₃ to C₆ α,β-ethylenically unsaturated carboxylic acids and monoesters of C₄ to C₆ unsaturated diacids, and which contain one or more kinds of metallic or organic cations associated with at least 5% of the acidic pendant groups of the polymer. Typical ionomers and methods of production are disclosed in, for example, U.S. Pat. Nos. 3,264,272, 4,911,451, 5,210,138, and 5,929,174; and WO 98/52981, 95/11929, 96/23009, 97/11995, and 97/02317, and described in COMPREHENSIVE POLYMER SCIENCE 755-772 (Colin Booth & Colin Price, ed. Pergamon Press 1989), in particular relating to ethylene-based materials.

The metal ion or ions suitable for forming the ionic copolymers of the present invention comprise mono, di or tri-valent metal ions in the Groups 1 through 13 of the Periodic Table of Elements. Embodiments include the following metal ions: Na⁺, K⁺, Li⁺, Cs⁺, Ag⁺, Hg⁺, Cu⁺, Be²⁺, Mg²⁺, Ca²⁺, Sr²⁺, Ba²⁺, Cu²⁺, Cd²⁺, Hg²⁺, Pb²⁺, Fe²⁺, Co²⁺, Ni²⁺, Zn²⁺, Al²⁺, Sc³⁺, Fe³⁺, Al³⁺ and Yt³⁺. In the various ions mentioned above, Mg²⁺, Na⁺ and Zn²⁺ are metals used in desirable embodiments. Reaction of the carboxylic acid groups of the ionomer and a metal ion derived from a desirable metal compound (metal oxide, metal chloride, etc.) is referred to as “neutralization”.

The ionomers useful in the present invention, either alone or as a blend of two or more ionomers, generally include more than 60 wt % α-olefin derived units in one embodiment by weight of the ionomer, and more than 70 wt % α-olefin derived units in another embodiment, and more than 80 wt % α-olefin derived units in one embodiment, and more than 85 wt % α-olefin derived units in yet another embodiment, and less than 95 wt % α-olefin derived units in another embodiment, and less than 85 wt % α-olefin derived units in another embodiment, and less than 75 wt % α-olefin derived units in yet another embodiment, and from 60 to 95 wt % α-olefin derived units in another embodiment, wherein a desirable range of α-olefin derived units that make up the ionomer is any combination of any upper limit with any lower limit described herein; and from 5 to 25 wt % of ethylenically copolymerizable acid monomers in one embodiment, and from 1 to 15 wt % of ethylenically copolymerizable acid monomers in another embodiment, and from 8 to 20 wt % of ethylenically copolymerizable acid monomers in another embodiment, wherein a desirable embodiment of a useful ionomer may comprise any upper wt % limit and any lower wt % limit of any ethylenically copolymerizable acid monomers described herein.

The polymer may be neutralized to form the ionomer to any degree between 10% to 100% based on the total amount of neutralizable carboxylate groups in one embodiment, and from 20% to 80% in another embodiment, and from 40% to 75% in yet another embodiment, and from 5% to 70% in yet another embodiment, provided the necessary scratch and mar resistance is maintained. A desirable level of neutralization may include any upper neutralization % limit and any lower neutralization % limit described herein.

One embodiment of an ionomer can be described as in the following structure (1): 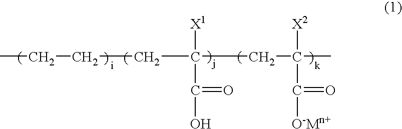
wherein X¹ and X² can be the same or different and are hydrogen or a C₁ to C₆ alkyl, and Mⁿ⁺is a metal ion or NH₄⁺. Of course, it is understood that when n is >1, such as with a divalent metal ion such as Zn²⁺, that charge neutrality for the ionomer is achieved by reaction with a total of n acid groups from either the same polymer chain, or an adjacent polymer chain. The structure (1) is not intended to be construed that the ionomer is a block copolymer or limited to being a block copolymer. The values of i, j, and k are determined by the following relationships (2) and (3):

$$\begin{matrix}\frac{j + k}{i + j + k} = Q & ( 2 ) \\ \frac{k}{j + k} = P & ( 3 )\end{matrix}$$

wherein Q is from 10 to 40% of the polymer units derived from the acidic monomer(s) relative to the total weight of the ionomer in one embodiment, and from 15 to 20% of polymer units derived from the acidic monomer(s) in another embodiment, and P is from 10 to 80% of the acidic groups neutralized with the metallic ions in one embodiment, and from 20 to 70% of the acidic groups neutralized with the metallic ions in another embodiment, and from 20 to 60% in yet another embodiment, and further ranges as stated above. The polymer component i, derived from ethylene in one embodiment, can be linear or branched.

The ionomers or blends of two or more ionomers should be capable of being formed into a sheet having a thickness of from 15 μm to 6 mm, and from 25 μm to 700 μm in another embodiment, and possess desired properties, i.e., a high or low gloss, scratch resistance, abrasion resistance, etc. Useful ionomers or ionomer blends have a peak melt temperature of greater than 75° C. in one embodiment, and between 75° C. and 150° C. in another embodiment, and between 75° C. and 95° C. in one embodiment, and between 80° C. and 90° C. in another embodiment; and a melt index (MI) of between 0.1 dg/min and 30 dg/min (ASTM D1238, 190/2.16) in one embodiment, from 0.2 to 8 dg/min in one embodiment, from 0.5 to 5 dg/min in another embodiment, and from 0.8 to 2.5 dg/min in yet another embodiment, wherein a desirable range may be any combination of any upper MI limit with any lower MI limit described herein.

The ionomers useful in the present invention should provide high scratch, abrasion and impact resistance to the wood article. The ionomers or ionomer blends have a 1% secant flexural modulus (ASTM D-790) of greater than 50 MPa in one embodiment, and greater than 100 MPa in another embodiment, and greater than 200 MPa in another embodiment, and greater than 400 MPa in yet another embodiment, between 50 and 400 MPa in one embodiment, and from 100 to 350 MPa in another embodiment. Desirable ionomers are ethylene methacrylic acid copolymer ionomers and ethylene acrylic acid copolymers ionomers and the like. Particularly desirable ionomers are those that are sodium, zinc or magnesium salts of acrylic acid or methacrylic acid copolymers.

Further, in a desirable embodiment, certain blends of ionomers based on ethylene acrylic acid copolymer neutralized with divalent and monovalent metal ions (cations) such as Zn²⁺ and Na⁺, display a synergistic MI “uplift” as disclosed in, for example, U.S. Pat. Nos. 5,210,138, and 5,929,174 are useful. In one embodiment of the invention, one or more of the ionomer layers that make up the laminate is a blend of a first ionomer having an MI value of from 0.6 to 1.0 dg/min, and a second ionomer having an MI value of from 2.1 to 3.0 dg/min. The blend of the first and second ionomers includes from 45 wt % to 95 wt % of the first ionomer in one embodiment, and from 55 wt % to 85 wt % of the first ionomer in another embodiment, and from 65 wt % to 80 wt % of the first ionomer in yet another embodiment, and from 72 wt % to 78 wt % of the first ionomer in yet another embodiment, and 75 wt % of the first ionomer in yet another embodiment, wherein a desirable range may include any upper wt % limit and any lower wt % limit described herein. The blends may include blends of two or more ionomers having different metallation (different metals and/or different % of metallation), different MI values, or a combination of variables.

Other examples of ionomers useful in the present invention include, but are not limited to, butadiene-acrylic acid copolymer ionomers, perfluorsulfonate ionomers, perfluorocarboxylate ionomers, telechelic polybutadiene ionomers, sulfonated ethylene-propylene-diene terpolymer ionomers, styrene-acrylic acid copolymer ionomers, sulfonated polystyrene ionomers, sulfonated polypentanamer ionomers, telechelic polyisobutylene sulfonated ionomers, alkyl methacrylate-sulfonate copolymer ionomers, styrene-based polyampholytes ionomers and acid-amine ionomers and the like. Typical examples of ionomers employing salts of carboxylic acid type pendent groups are disclosed in GB 1,011,981; U.S. Pat. Nos. 3,264,272; 3,322,734; 3,338,734; 3,355,319; 3,522,222; and 3,522,223. Typical examples of ionomers employing phosphonate-type pendent groups include those disclosed in U.S. Pat. Nos. 3,094,144; 2,764,563, 3,097,194; and 3,255,130. Typical examples of ionomers employing sulfonate-type pendent groups include those disclosed in U.S. Pat. Nos. 2,714,605; 3,072,618; and 3,205,285. Other useful ionomers are disclosed generally in U.S. Pat. Nos. 5,631,328, 5,631,328, 5,554,698, 4,801,649, 5,320,905, 5,973,046, and 4,569,865.

Ionomers comprising copolymers of ethylene derived units and acrylic acid (AA) derived units are desirable. Examples of commercially available ionomers include, but are not limited to, IOTEK ionomers (ExxonMobil Chemical Company, Houston, Tex.), such as IOTEK 8000, a 45% sodium neutralized ethylene-based ionomer of 15 wt % acrylic acid (prior to neutralization), and IOTEK 7030, a 25% zinc neutralized ethylene-based ionomer of 15 wt % acrylic acid, and SURLYN ionomers (DuPont Company, Wilmington, Del.).

The one or more ionomer layers may contain additives such as antioxidants, pigments or dyes, and other agents. In one embodiment, at least one layer of ionomer in the final composite article will have a pigment, antioxidant, or other additives. For external uses, it is desirable to add a UV stabilizer such as TINUVEN 791 (CIBA Specialty Chemicals) or UVASIL 2000 HM or LM (Great Lakes Chemicals), both silicon based compositions. Also, for scratch resistance, it is advantageous to add siloxane based compositions such as MB50-001 and/or MB50-321 (Dow Corning Corporation). Effective levels are known in the art and depend on the details of the base polymers, the fabrication mode and the requirements of the end application. In addition, hydrogenated and/or petroleum hydrocarbon resins and other plasticizers may be used as modifiers.

Other examples of additives include one or more of the following: heat stabilizers or antioxidants, neutralizers, slip agents, antiblock agents, pigments (non-metallic, metallic, or metal flake), antifogging agents, antistatic agents, clarifiers, nucleating agents, ultraviolet absorbers or light stabilizers, fillers, rosins or rosin esters, waxes, plasticizers and other additives in conventional amounts.

Substrate

The wood substrate may be any suitable elongated piece of wood. In one embodiment, the wood substrate may comprise natural wood, pressure treated wood, laminated wood, composite wood, or combinations thereof. In another embodiment, the wood substrate may be selected from the group consisting of natural wood, pressure treated wood, laminated wood, and combinations thereof.

In another embodiment, the wood substrate is select lumber. Select lumber is an excellent quality wood for use when appearance and finishing are most important. The grades of the select lumber are: B and Better grade, which has minute or no blemishes; C select grade, which has some minor defects such as small knots; and D select grade, which has larger imperfections that can be concealed by paint.

In another embodiment, the wood substrate is common lumber. Common lumber generally has more defects than select lumber and is used for construction and general-purpose projects. The grades of common lumber are No. 1 grade, that contains tight knots and few blemishes; No. 2 grade, that has more and larger knots and blemishes; No. 3 grade, that has loose knots, knotholes, and other flaws; No. 4 grade, that is low quality; and No. 5 grade, where the appearance is not important.

In yet another embodiment, the wood substrate is any suitable hardwood. Hardwoods are generally from deciduous trees. Such trees generally have broad, flat leaves. Wood hardness varies among species of hardwood woods, and some can be softer than some softwood woods. The wood substrate may include at least one hardwood. The hardwood may also be selected from the group consisting of acacia; alder; almond; ash; European ash; aspen; African black; balsa; basswood; beech; birch; boxwood; Brazilian; brazilwood; bubinga; buckeye; butternut; buttonwood; carbob; cherry; chestnut; Christ's thorn; cocobolo; common box; cork wood; cottonwood; date palm; dom/doum palm; ebony; elm; English; European; hackberry; hickory; hornbeam; iron wood; jelutong; kingwood; lime; linden; locust; maple; mahogany; nabk; oak; olive; persea; plane; plum; purpleheart; rosewood; sassafras; sidder; sycamore; storax tree; sweet gum; tamarisk; teak; tulipwood; tulip tree; walnut; willow; popular; and combinations thereof.

In one embodiment, the wood substrate may be any suitable softwood. Softwoods are generally from coniferous trees. Such trees are generally evergreen, bear cones, and/or have needles. The wood substrate may include at least one softwood. The softwood may also be selected from the group consisting of cedar; cyprus; juniper; savin; hemlock; western; fir; larch; pine; redwood; spruce; yew; and combinations thereof.

The wood substrate may also include burl wood, face burl wood, wormed wood, blackened wood, or combinations thereof.

The wood substrate may also be any combination of at least one hardwood and at least one softwood. In another embodiment, the wood substrate is a laminated wood substrate. In yet another embodiment, the wood substrate may include a veneer of a higher quality wood disposed on a lesser quality wood.

The wood substrate may also include pressure treated wood. Pressure treated wood is lumber or plywood that has been pressure-impregnated with a preservative such as CCA as discussed in the BACKGROUND. Methods and materials used to produce pressure treated woods are well known in the art.

A general process to produced pressure treated wood would proceed as follows. Common species of lumber, timbers and/or plywood are loaded onto trams and pushed into a large horizontal treating cylinder. The cylinder door is sealed, and a vacuum is applied to remove most of the air from the cylinder and the wood cells. A preservative is pumped into the cylinder and forced under pressure into the wood. At the end of the process, excess treating solution is removed and recycled. The treated wood is then removed. Exemplary preservative products are available from Arch Wood Protection, Inc. (Smyrna, Ga.). Such products may be used to produce Wolmanized Pressure-treated wood, Wolmanized Extra Water Repellant Lumber, Wolmanized Outdoor Wood, Wolmanized Natural Select Wood, Thompsonized Wood, Dricon Fire Retardant Treated Wood, and FRX Exterior Frt Wood.

The wood substrate as described above may also be primed using methods and materials known in the art for priming wood and other cellulosic materials.

Tie-Layer

In one embodiment, the tie-layer is made from a (co)extrudable tie resin (CTR). In another embodiment, the tie-layer may comprise one or more layers of CTRs. In another embodiment, a suitable CTR includes blends of CTRs (as described below).

In one embodiment, the tie-layer material is a copolymer of one or more C₂ to C₁₀ alpha-olefins copolymerized with one of more of the following monomers:

Acidic monomers of that may be represented by the general formula: 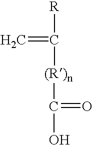
where R is H or a C₁ to C₁₀ hydrocarbon, n is 0 or 1 and R′ is a C₁ to C₁₀ hydrocarbon.

In some embodiments, the polymers of this invention may be made using mixtures of acid monomers with different R and R′ substituents. Preferred embodiments for this type of monomer are acrylic acid and methacrylic acid.

Vinyl ester monomers represented by the formula: 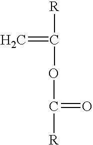
where each R is independently H or a C1 to C10 hydrocarbon. A preferred embodiment for this type of monomer is vinyl acetate.

Other ester monomers which may be represented by the general formula: 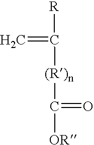
where R is independently H or a C₁ to C₁₀ hydrocarbon; R′ is independently a C₁ to C₁₀ hydrocarbon; R″ is independently a C₁ to C₁₀ hydrocarbon; and n is 0 or 1. The polymers of this invention may be made using mixtures of monomers with different R, R′ and R″ groups.

Preferred embodiments include the copolymers of ethylene and/or propylene with one or more ester monomers methyl (meth)acrylate, ethyl (meth)acrylate, propyl (meth)acrylate, or butyl (meth)acrylate.

Diacid monomers such as unsaturated diacids, anhydrides of unsaturated diacids, or monoesters of unsaturated diacids. Suitable unsaturated diacids include, but are not limited to, maleic acid, itaconic acid, citraconic acid and 2-pentenedioic acid and their corresponding anhydrides and monoesters. Illustrative examples may be represented by the general formulas: 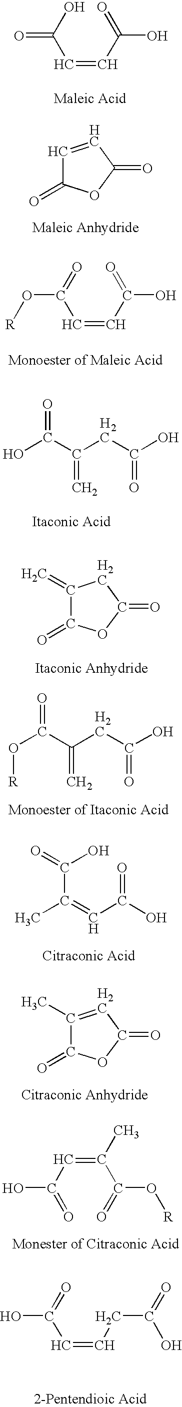 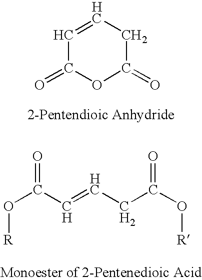
where each R and R′ is independently H or a C₁ to C₁₀ hydrocarbon; wherein each R and R′ are different.

Preferred embodiments of diacid monomers include maleic anhydride and monoalkyl maleate.

Epoxy-containing monomers such as glycidyl acrylate or glycidyl methacrylate optionally with other ester monomers. Epoxy-containing monomers may be represented by the general formula: 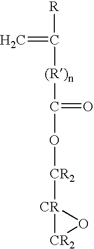
where each R is independently H or a C₁ to C₁₀ hydrocarbon, R′ is independently a C₁ to C₁₀ hydrocarbon and n is 0 or 1. The polymers of this invention may be made using mixtures of monomers with different R and R′ groups.

A preferred embodiment for this type of monomer is glycidyl methacrylate.

6. Carbon monoxide.

In another embodiment, the tie-layer material is a polymer which contains the following amine-containing structures:

In another embodiment, a CTR may include amine-containing polymers having amine groups that may be represented by the general formula: 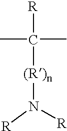
where each R is independently H or a C₁ to C₁₀ hydrocarbon, R′ is a C₁ to C₁₀ hydrocarbon and n is 0 or 1.

In a preferred embodiment, R is H and n is 0.

In another embodiment, the tie-layer material consists of a polymer of one or more C₂ to C₁₀ alpha-olefins, optionally copolymerized with one or more monomers of types 2, 3 or 6 above, and subsequently grafted with a monomer of type 1, 4 or 5. Each polymer molecule can be grafted with these monomers at several places along the polymer chain.

In one embodiment of the invention, the tie-layer material is a polymer made using one or more of the monomers described above blended with another polymer made from one or more alpha-olefin monomers.

The tie-layer may have a thickness in the range of from 2.5 μm to 1 mm in one embodiment, and from 25 μm to 650 μm in another embodiment, from 2.5 μm to 400 μm in yet another embodiment, from 2 μm to 100 μm in yet another embodiment, and from 10 μm to 1 mm in yet another embodiment. Desirable ranges may include any combination of any upper tie-layer thickness limit and any lower tie-layer thickness limit described herein.

The tie-layer may also include additives as described above for the ionomer layers, such as pigments, dyes, antioxidants, antiozonants, and other agents to improve its performance. Examples include one or more of the following: heat stabilizers or antioxidants, neutralizers, slip agents, antiblock agents, pigments, antifogging agents, antistatic agents, clarifiers, nucleating agents, ultraviolet absorbers or light stabilizers, fillers, rosins or rosin esters, waxes, plasticizers and other additives in conventional amounts.

CTRs useful in the invention have a melt index (MI ASTM D1238, 190/2.16) of from 0.1 to 60 dg/min in one embodiment, from 0.5 to 30 dg/min in another embodiment, from 1 to 20 dg/min in yet another embodiment, and from 2.0 to 10 dg/min in yet another embodiment, a desirable range including a combination of any upper MI limit and any lower MI limit disclosed herein.

The ionomer and tie layer of the present invention can be coextruded using conventional equipment well known in the industry. In one embodiment, the extrusion process conditions are as follows. The temperature controllers of the extruder(s) used to process the ionomer(s) are set at 180° C. to 225° C. in one embodiment, yielding a final material melt temperature of 200° C. to 215° C. or higher. Desirably, the ionomer material melt temperature is greater than 200° C. in another embodiment. The temperature controllers of the extruder(s) used to process the tie resins are set for 195° C. to 225° C. in another embodiment, yielding a final material melt temperature of 210° C. to 230° C. The viscosity of each material being extruded should be closely matched to each other, at their respective processing temperatures, to achieve the targeted gloss level.

In a preferred embodiment, extruders are used with dies designed to provide thermal isolation and/or control of each of the materials being processed. The temperature control can be achieved by any suitable means such as insulation and/or cooling and/or heating elements that can be controlled by electricity, steam, oil, or other gases or liquids. The die may have separate extrusion layers within the die, and have a means by which to heat the materials to a temperature higher than the melt temperature going into the die. For example, the die may be being controlled to a temperature from about 150° C. to 200° C., while one or more of the material streams that will make up the coating on the wood substrate may be further heated to from 230° C. to 270° C.

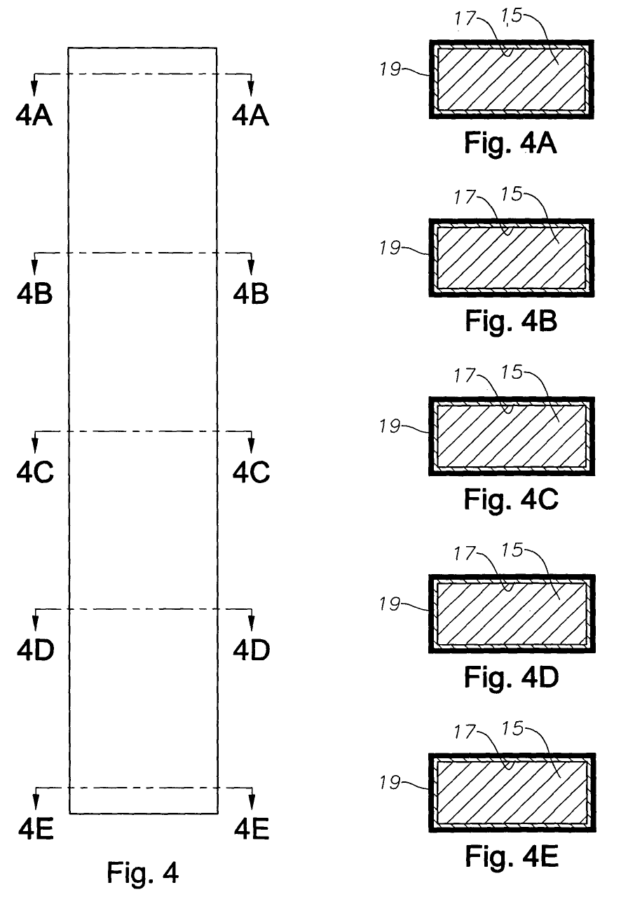

The final coating may have any number of layers of ionomer and/or tie-layer materials. See FIG. 4. Embodiments of the coating include one layer of ionomer and one layer of a CTR. Another embodiment includes two layers of ionomer and one layer of a CTR. In yet another embodiment of the coating includes two layers of ionomer and two layers of tie-layer material such as a CTR and/or a blend of a CTR and polyolefin. In yet another embodiment of the coating, there may be two layers of ionomer and one layer of a CTR/polyolefin blend as the tie-layer.

In one embodiment of the coating of the invention, two layers of ionomer may be coextruded with one layer of tie-layer material, wherein the ionomers are Zn²⁺ and Na⁺ salts of ethylene acrylic acid copolymers and the tie-layer material is ethylene glycidyl methacrylate copolymer. Another embodiment includes two ionomer layers of zinc and sodium salts of ethylene acrylic acid copolymers and a tie-layer including a polypropylene/ethylene butyl acrylate copolymer (EBA) blend such as, for example, a polypropylene impact copolymer present from 10 to 90 wt % in one embodiment, and from 30 to 70 wt % in another embodiment, and from 40 to 60 wt % in yet another embodiment in the blend, and EBA present from 10 to 90 wt % in one embodiment, from 30 to 70 wt % in another embodiment, and from 40 to 60 wt % in yet another embodiment in the blend.

In yet another example of the coating, two ionomer layers as described above may be present with one layer of tie-layer material, the tie-layer including a blend of high density polyethylene (HDPE) and EBA. The HDPE may be present in the range from 10 to 90 wt % in one embodiment, from 25 to 75 wt % in another embodiment, and from 35 to 65 wt % in yet another embodiment, while the EBA is present in the range from 10 to 90 wt % in one embodiment, from 25 to 75 wt % in another embodiment, and from 35 to 65 wt % in yet another embodiment.

In yet another example of the coating, two ionomer layers may be present with one tie-layer material, wherein the tie-layer material is a blend of the following: HDPE and linear low density polyethylene (LLDPE) in a ratio of from 75/25 wt % to 85/15 wt %, blended with ethylene methyl acrylate (EMA), the EMA present in the tie-layer blend from 10 to 90 wt % in one embodiment, from 25 to 75 wt % in another embodiment, and from 35 to 65 wt % in yet another embodiment.

In yet another example of the coating, two ionomer layers may be present with one tie-layer material, wherein the tie-layer material is a blend of the following: linear low density polyethylene blended with ethylene acrylic acid (EAA), the EAA present in the tie-layer blend from 10 to 90 wt % in one embodiment, from 25 to 75 wt % in another embodiment, and from 35 to 65 wt % in yet another embodiment.

In yet another example of the coating, two layers of ionomer as described above may be coextruded with two layers of tie-layer material. Examples of this tie-layer configuration include one layer of an EMA and another layer of a blend of polypropylene and ethylene ethyl acrylate copolymer (EEA), specifically, a polypropylene impact copolymer present from 10 to 90 wt % in one embodiment, and from 30 to 70 wt % in another embodiment, and from 40 to 60 wt % in yet another embodiment in the blend, and EEA present from 10 to 90 wt % in one embodiment, from 30 to 70 wt % in another embodiment, and from 40 to 60 wt % in yet another embodiment in the blend.

The final coating may have any number of layers of ionomer and tie-layer materials. In one embodiment, the coating is two layers, three in another embodiment, and four layers in yet another embodiment. In one embodiment, the ionomer layer or layers, are from 13 μm to 1 mm. In another embodiment, the ionomer layer (or layers) is from 25 μm to 380 μm. In yet another embodiment, the ionomer layer is from 200 μm to 380 μm. The tie-layer can be of comparable thickness ranges, making the overall thickness of the coating is from 100 μm to 5 mm in one embodiment, or from 250 μm to 3 mm in yet another embodiment.

In certain embodiments, the melt viscosity, or melt indexes (MI, ASTM D1238 test method, at 190° C. and 2.16 kg load) of each adjoining layer are within less than 5 dg/min of each other in one embodiment, within less than 4 dg/min of each other in another embodiment, and less than 3 dg/min from one another in yet another embodiment, and from within 1 to 4 dg/min of the layer in which it is in direct contact with during coextrusion in another embodiment, and within 2 to 3 dg/min of one another in another embodiment. However, one skilled in the art will recognize that the viscosity of each material to be extruded should be closely matched to each other, at their respective processing temperatures, to achieve the targeted level gloss and layer thickness uniformity.

Wood Article Formation

One preferred method of forming the wood article is through crosshead extrusion. Crosshead extrusion is known in the art. See, e.g., Totten; Wire Coating, Plastics Processing, ENCYCLOPEDIA OF POLYMER SCIENCE, John Wiley & Sons, 273 (New York: 1988); Dies for Extrusion, Fisher, E. G., EXTRUSION OF PLASTICS, John Wiley & Sons, 212-215 (New York: 1976); Wire and Cable Coaters' Handbook, E.I. du Pont de Nemours & Co. (Inc.), 18-23 (Wilington, Del.: 1968); and Wire and Cable Covering, Griff, Allan L., PLASTICS EXTRUSION TECHNOLOGY, Reinhold Book Corporation, 192-203 (New York: 1962); all herein incorporated by reference in their entireties.

In general, the coextrusion process includes first melting each material in an appropriate device and extruding these molten or semi-molten materials together through a die. The various layers can be combined in the melt stage via appropriate mechanisms known in the art prior to exiting the die, or combined after exiting the die.

An exemplary method would proceed as follows. A wood article is manufactured by introducing the wooden substrate along its longitudinal axis into a crosshead die mounted on an extrusion head. An ionomer resin is extruded upon the wood substrate as it passes through the crosshead die and is allowed to cool once the extrusion process has been completed. Preferably, the ionomer resin, now, an ionomer layer, is chilled immediately by water.

Although crosshead extrusion is a preferred method of applying ionomers to wood substrates, other methods include wrapping the wood substrate with one or more layers of ionomer-based film(s) or extruding a tape of ionomer in a helical wrap around the wood substrate. In the former process, the ionomer film is subsequently heated to thermally bond the overlapping layers of film together and to bond the innermost layer to the wood substrate. Alternatively, the ionomer film can be adhesively bonded both to the wood substrate and to the overlapped layers of film. In one embodiment, the film consists of both one or more ionomer layers and one or more tie-layers produced from CTRs as described elsewhere in this application.

In the latter process, an adaptation of the extrusion process used to make some forms of plastic tubes and hoses (see, e.g., U.S. Pat. No. 3,910,808), the wood substrate is rotated as the ionomer, melt extruded in flat profile, is helically wrapped onto it as it moves forward in the apparatus.

These alternative approaches to applying ionomer to the surface of a wood substrate work best with wood substrates of circular or essentially circular cross section, or regular polygonal cross section with five or more sides.

Optionally, in one embodiment, the wood article may be formed with a plurality of perforations or slits, through the ionomer layer, normally located along the longitudinal axis of the wood article as disclosed in Totten. These perforations are preferably about 6 mm in length and are spaced by a distance, of 50 to 75 mm along the longitudinal axis of the wood article. Alternatively, the perforations may range in length from a pin hole to 15 mm. Generally, pin hole perforations are spaced on approximately 25 to 50 mm centers. The perforations can either be formed with the ionomer layer concurrently during the extrusion process or thereafter.

After wood article formation, the ionomer layer thickness is from less than 2.0 mm, preferably, the ionomer layer thickness is from less than 1.8 mm, more preferably, the ionomer layer thickness is from less than 1.6 mm, even more preferably, the ionomer layer thickness is from less than 1.4 mm, and, even more preferably, the ionomer layer thickness is from less than 1.2 mm. In one embodiment, the ionomer layer thickness is uniform along the perimeter of the wood article. Conversely, in another embodiment, the ionomer layer thickness is non-uniform along the perimeter of the wood article.

Due to the methods of forming the wood article and the implicit qualities of the wood substrate, the wood article has an essentially uniform cross section as defined and explained above.

In one embodiment, the wood article is formed by extruding a layer of ionomer onto an elongated piece of wood. In another embodiment, the wood article is formed by simultaneously coextruding one or more ionomer layers and one or more tie-layers in a coextrusion process. The coextrusion process can include 2, 3, 4 or more coextruded layers.

In embodiments described above, the wood substrate becomes coated with a layer of ionomer, either as the only material or in conjunction with an optional tie-layer (See FIG. 4), on all of its elongated sides, leaving the two ends of the elongated piece of wood uncoated.

The wood articles may also include end caps of different or the same materials as the ionomer layer. End caps can be designed to fit over the end of the wood article and can be very simple shapes such as a flat end cap or more complex shapes such as pyramidal, conical, hemispherical, frusta (truncated cones or pyramids) or shapes designed to match gothic, Greek or Roman structures. The caps may be simply placed onto the ends of the wood articles, adhesively bonded to the ends of the wood articles, or thermally sealed or welded to the ends of the wood articles. They may be produced by methods well known in the art. A preferred method of production is injection molding or thermoforming.

### INDUSTRIAL APPLICATIONS

The wood articles of the present invention are useful in construction. In particular, the wood articles are useful as veneers; wall-paneling; trim/trimming; flooring; molding; planks; doors; boards; fencing; fence posts; crates; boxes; frames; window frames; siding; finishing; ladders; closet lining; shingles; posts; blinds; Venetian blinds; decks and patios; walkways/boardwalks; garage doors; thresholds; awnings; and the like.

The wood articles of the present invention are also useful in furniture. In particular, the wood articles are useful for cabinets; desks; and chests. Additionally, they are useful for outdoor furniture such as chairs, rockers; benches; picnic tables; planters; and garden frames. Furthermore, the wood articles are useful for indoor furniture such as countertops; bars; and vanities.

The wood articles may also be used in recreational structures such as play structures; swing-sets; “jungle gyms”; toy sets; tree houses; bird houses; bird feeders; and barometer cases.

Additionally, the wood articles may be used in marine, aviation, and vehicular equipment such as boat frames; trim; masts; spars; running boards; and boat docks.

Further, the wood articles may be used for tools such as tool handles and other tool components.

In an embodiment of the invention:
1. A wood article comprising a wood substrate cross head extruded with an ionomer layer; wherein the wood substrate is encased by the ionomer layer.
2. The wood article of paragraph 1, wherein the wood substrate comprises natural wood, pressure treated wood, laminated wood, or combinations thereof.
3. The wood article of paragraph 1, wherein the wood substrate comprises select lumber.
4. The wood article of paragraph 1, wherein the wood substrate comprises common lumber.
5. The wood article of paragraph 1, wherein the wood substrate comprises at least one hardwood.
6. The wood article of paragraph 5, wherein the at least one hardwood is selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; maple; mahogany; oak; olive; persea; plum; purpleheart; rosewood; sassafras; sidder; sycamore; storax; sweet gum; tamarisk; teak; tulipwood; walnut; willow; popular; and combinations thereof.
7. The wood article of paragraph 1, wherein the wood substrate comprises at least one softwood.
8. The wood article of paragraph 7, wherein the at least one softwood is selected from the group consisting of cedar, cyprus, juniper, savin, hemlock; western; fir; larch; pine; redwood; spruce; yew; and combinations thereof.
9. The wood article of any of the preceding paragraphs, wherein the wood substrate comprises a primed wood.
10. The wood article of paragraph 9, whereby the primed wood is primed using an aqueous dispersion of an acid containing polymer.
11. The wood article of paragraph 10, wherein the acid containing polymer is ethylene (meth)acrylic acid copolymer.
12. The wood article of paragraph 11, wherein the ethylene (meth)acrylic acid copolymer comprises from about 10 wt % to about 30 wt % polymer units derived from the acid monomers.
13. The wood article of paragraph 1, wherein the wood substrate comprises burl wood, face burl wood, wormed wood, blackened wood, or combinations thereof.
14. The wood article of any of the preceding paragraphs, wherein the ionomer layer comprises a first ionomer layer and a second ionomer layer.
15. The wood article of paragraph 14, wherein the first ionomer layer or the second ionomer layer is pigmented, natural, or clear.
16. The wood article of any of the preceding paragraphs, wherein the ionomer layer is transparent.
17. The wood article of any of the preceding paragraphs, wherein the wood article further comprises a tie-layer.
18. The wood article of paragraph 17, wherein the tie-layer comprises a copolymer of a C₂ to C₁₀ alpha-olefin copolymerized with an alkyl (meth)acrylate.
19. The wood article of paragraph 17, wherein the tie-layer comprises a terpolymer of a C₂ to C₁₀ alpha-olefin copolymerized with an alkyl (meth)acrylate and an acidic monomer.
20. The wood article of paragraph 19, wherein the acidic monomer is (meth)acrylic acid.
21. The wood article of paragraph 17, wherein the tie-layer comprises an epoxy containing polymer.
22. The wood article of paragraph 17, wherein the tie-layer comprises an ethylene (meth)acrylic acid copolymer or a blend of an ethylene (meth)acrylic acid copolymer with a polyolefin and/or an acid terpolymer.
23. The wood article of paragraph 17, wherein the tie-layer comprises an alkyl(meth)acrylate ester copolymer or a blend of an alkyl(meth)acrylate ester copolymer with a polyolefin and/or an acid copolymer or terpolymer.
24. The wood article of any of the preceding paragraphs, wherein the wood article further comprises a plurality of valves or perforations.
25. The wood article of any of the preceding paragraphs, wherein the wood article has an essentially uniform cross section.
26. The wood article of any of the preceding paragraphs, wherein the ionomer layer has a uniform ionomer layer thickness.
27. The wood article of any of the preceding paragraphs, wherein the ionomer layer has an ionomer layer thickness of 2.0 mm or less.
28. The wood article of any of the preceding paragraphs, wherein the wood substrate does not comprise maple wood.
29. A method to produce a wood article comprising the steps of obtaining a wood substrate and crosshead extruding the wood substrate with an ionomer layer to form the wood article.
30. A method of forming a wood article comprising the steps of:
   selecting a wood substrate;
   introducing the wood substrate along its longitudinal axis into a crashed die, the crashed die mounted on a plastic extrusion machine;
   subjecting said wood substrate to a vacuum;
   extruding an ionomer layer on the wood substrate; and
   forming a wood article.
31. The method of paragraph 29 or 30, wherein the wood substrate comprises natural wood, pressure treated wood, laminated wood, or combinations thereof.
32. The method of paragraph 29 or 30, wherein the wood substrate comprises select lumber.
33. The method of paragraph 29 or 30, wherein the wood substrate comprises common lumber.
34. The method of paragraph 29 or 30, wherein the wood substrate comprises at least one hardwood.
35. The method of paragraph 34, wherein the at least one hardwood is selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; maple; mahogany; oak; olive; persea; plum; purpleheart; rosewood; sassafras; sidder; sycamore; storax; sweet gum; tamarisk; teak; tulipwood; walnut; willow; popular; and combinations thereof.
36. The method of paragraph 29 or 30, wherein the wood substrate comprises at least one softwood.
37. The method of paragraph 36, wherein the at least one softwood is selected from the group consisting of cedar, cyprus, juniper, savin, hemlock; western; fir; larch; pine; redwood; spruce; yew; and combinations thereof.
38. The method of paragraph 29 or 30, wherein the wood substrate comprises a primed wood.
39. The method of paragraph 38, whereby the primed wood is primed using an aqueous dispersion of an acid containing polymer.
40. The method of paragraph 39, wherein the acid containing polymer is ethylene (meth)acrylic acid copolymer.
41. The method of paragraph 40, wherein the ethylene (meth)acrylic acid copolymer comprises from about 10 wt % to about 30 wt % polymer units derived from the acid monomers.
42. The method of paragraph 29 or 30, wherein the wood substrate comprises burl wood, face burl wood, wormed wood, blackened wood, or combinations thereof.
43. The method of any of the preceding paragraphs, wherein the ionomer layer comprises a first ionomer layer and a second ionomer layer.
44. The method of paragraph 43, wherein the first ionomer layer or the second ionomer layer is pigmented, natural, or clear
45. The method of any of the preceding paragraphs, wherein the ionomer layer is transparent.
46. The method of any of the preceding paragraphs, wherein the wood article further comprises a tie-layer.
47. The method of paragraph 46, wherein the tie-layer comprises a copolymer of a C₂ to C₁₀ alpha-olefin copolymerized with an alkyl (meth)acrylate.
48. The method of paragraph 46, wherein the tie-layer comprises a terpolymer of a C₂ to C₁₀ alpha-olefin copolymerized with an alkyl (meth)acrylate and an acidic monomer.
49. The method of paragraph 48, wherein the acidic monomer is (meth)acrylic acid.
50. The method of paragraph 46, wherein the tie-layer comprises an epoxy containing polymer.
51. The method of paragraph 46, wherein the tie-layer comprises an ethylene (meth)acrylic acid copolymer or a blend of an ethylene (meth)acrylic acid copolymer with a polyolefin and/or an acid terpolymer.
52. The method of paragraph 46, wherein the tie-layer comprises an alkyl(meth)acrylate ester copolymer or a blend of an alkyl(meth)acrylate ester copolymer with a polyolefin and/or an acid copolymer or terpolymer.
53. The method of any of the preceding paragraphs, wherein the wood article further comprises a plurality of valves or perforations.
54. The method of any of the preceding paragraphs, wherein the wood article has an essentially uniform cross section.
55. The method of any of the preceding paragraphs, wherein the ionomer layer has a uniform ionomer layer thickness.
56. The method of any of the preceding paragraphs, wherein the ionomer layer has an ionomer layer thickness of 2.0 mm or less.
57. An article produced by the method of any of the preceding paragraphs.

The aforementioned industrial applications may be combined with any of the embodiments described in the SUMMARY as well as any embodiments as claimed.

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the true scope of the present invention.

Terms that are or may be trademarked in some jurisdictions are used in the description. These terms are written in all capital letters, and is understood to recognize such trademarks. For brevity, markings such as “™” or “®” are not always used.

All priority documents are herein fully incorporated by reference for all jurisdictions in which such incorporation is permitted. Further, all documents cited herein, including testing procedures, publications, patents, journal articles, etc., are herein fully incorporated by reference for all jurisdictions in which such incorporation is permitted.

1. A wood article comprising a wood substrate cross head extruded with an ionomer layer; wherein the wood substrate is encased by the ionomer layer.

2. The wood article of claim 1, wherein the wood substrate comprises natural wood, pressure treated wood, laminated wood, or combinations thereof.

3. The wood article of claim 1, wherein the wood substrate comprises select lumber.

4. The wood article of claim 1, wherein the wood substrate comprises common lumber.

5. The wood article of claim 1, wherein the wood substrate comprises at least one hardwood.

6. The wood article of claim 5, wherein the at least one hardwood is selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; maple; mahogany; oak; olive; persea; plum; purpleheart; rosewood; sassafras; sidder; sycamore; storax; sweet gum; tamarisk; teak; tulipwood; walnut; willow; popular; and combinations thereof.

7. The wood article of claim 1, wherein the wood substrate comprises at least one softwood.

8. The wood article of claim 7, wherein the at least one softwood is selected from the group consisting of cedar; cyprus; juniper; savin; hemlock; western; fir; larch; pine; redwood; spruce; yew; and combinations thereof.

9. The wood article of claim 1, wherein the wood substrate comprises a primed wood.

10. The wood article of claim 9, whereby the primed wood is primed using an aqueous dispersion of an acid containing polymer.

11. The wood article of claim 10, wherein the acid containing polymer is ethylene (meth)acrylic acid copolymer.

12. The wood article of claim 11, wherein the ethylene (meth)acrylic acid copolymer comprises from about 10 wt % to about 30 wt % polymer units derived from the acid monomers.

13. The wood article of claim 1, wherein the wood substrate comprises burl wood, face burl wood, wormed wood, blackened wood, or combinations thereof.

14. The wood article of claim 1, wherein the ionomer layer comprises a first ionomer layer and a second ionomer layer.

15. The wood article of claim 14, wherein the first ionomer layer or the second ionomer layer is pigmented, natural, or clear.

16. The wood article of claim 1, wherein the ionomer layer is transparent.

17. The wood article of claim 1, wherein the wood article further comprises a tie-layer.

18. The wood article of claim 17, wherein the tie-layer comprises a copolymer of a C₂ to C₁₀ alpha-olefin copolymerized with an alkyl (meth)acrylate.

19. The wood article of claim 17, wherein the tie-layer comprises a terpolymer of a C₂ to C₁₀ alpha-olefin copolymerized with an alkyl (meth)acrylate and an acidic monomer.

20. The wood article of claim 19, wherein the acidic monomer is (meth)acrylic acid.

21. The wood article of claim 17, wherein the tie-layer comprises an epoxy containing polymer.

22. The wood article of claim 17, wherein the tie-layer comprises an ethylene (meth)acrylic acid copolymer or a blend of an ethylene (meth)acrylic acid copolymer with a polyolefin and/or an acid terpolymer.

23. The wood article of claim 17, wherein the tie-layer comprises an alkyl(meth)acrylate ester copolymer or a blend of an alkyl(meth)acrylate ester copolymer with a polyolefin and/or an acid copolymer or terpolymer.

24. The wood article of claim 1, wherein the wood article further comprises a plurality of valves or perforations.

25. The wood article of claim 1, wherein the wood article has an essentially uniform cross section.

26. The wood article of claim 1, wherein the ionomer layer has a uniform ionomer layer thickness.

27. The wood article of claim 1, wherein the ionomer layer has an ionomer layer thickness of 2.0 mm or less.

28. A wood article comprising a wood substrate and an ionomer layer;
wherein the wood substrate is encased by the ionomer layer; and
wherein the wood substrate does not comprise maple wood.

29. The wood article of claim 28, wherein the wood substrate comprises natural wood, pressure treated wood, laminated wood, or combinations thereof.

30. The wood article of claim 28, wherein the wood substrate comprises select lumber.

31. The wood article of claim 28, wherein the wood substrate comprises common lumber.

32. The wood article of claim 28, wherein the wood substrate comprises at least one hardwood.

33. The wood article of claim 32, wherein the at least one hardwood is selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; mahogany; oak; olive; persea; plum; purpleheart; rosewood; sassafras; sidder; sycamore; storax; sweet gum; tamarisk; teak; tulipwood; walnut; willow; popular; and combinations thereof.

34. The wood article of claim 28, wherein the wood substrate comprises at least one softwood.

35. The wood article of claim 34, wherein the at least one softwood is selected from the group consisting of cedar; cyprus; juniper; savin; hemlock; western; fir; larch; pine; redwood; spruce; yew; and combinations thereof.

36. The wood article of claim 28, wherein the wood substrate comprises a primed wood.

37. The wood article of claim 36, whereby the primed wood is primed using an aqueous dispersion of an acid containing polymer.

38. The wood article of claim 37, wherein the acid containing polymer is ethylene (meth)acrylic acid copolymer.

39. The wood article of claim 38, wherein the ethylene (meth)acrylic acid copolymer comprises from about 10 wt % to about 30 wt % polymer units derived from the acid monomers.

40. The wood article of claim 28, wherein the wood substrate comprises burl wood, face burl wood, wormed wood, blackened wood, or combinations thereof.

41. The wood article of claim 28, wherein the ionomer layer comprises a first ionomer layer and a second ionomer layer.

42. The wood article of claim 41, wherein the first ionomer layer or the second ionomer layer is pigmented, natural, or clear.

43. The wood article of claim 28, wherein the ionomer layer is transparent.

44. The wood article of claim 28, wherein the wood article further comprises a tie-layer.

45. The wood article of claim 44, wherein the tie-layer comprises a copolymer of a C₂ to C₁₀ alpha-olefin copolymerized with an alkyl (meth)acrylate.

46. The wood article of claim 44, wherein the tie-layer comprises a terpolymer of a C₂ to C₁₀ alpha-olefin copolymerized with an alkyl (meth)acrylate and an acidic monomer.

47. The wood article of claim 46, wherein the acidic monomer is (meth)acrylic acid.

48. The wood article of claim 44, wherein the tie-layer comprises an epoxy containing polymer.

49. The wood article of claim 44, wherein the tie-layer comprises an ethylene (meth)acrylic acid copolymer or a blend of an ethylene (meth)acrylic acid copolymer with a polyolefin and/or an acid terpolymer.

50. The wood article of claim 44, wherein the tie-layer comprises an alkyl(meth)acrylate ester copolymer or a blend of an alkyl(meth)acrylate ester copolymer with a polyolefin and/or an acid copolymer or terpolymer.

51. The wood article of claim 28, wherein the wood article further comprises a plurality of valves or perforations.

52. The wood article of claim 28, wherein the wood article has an essentially uniform cross section.

53. The wood article of claim 28, wherein the ionomer layer has a uniform ionomer layer thickness.

54. The wood article of claim 28, wherein the ionomer layer has an ionomer layer thickness of 2.0 mm or less.

55. A wood article comprising:
a wood substrate; and
an ionomer layer;
wherein the article has an essentially uniform cross section.

56. The wood article of claim 55, wherein the wood substrate comprises natural wood, pressure treated wood, laminated wood, or combinations thereof.

57. The wood article of claim 55, wherein the wood substrate comprises select lumber.

58. The wood article of claim 55, wherein the wood substrate comprises common lumber.

59. The wood article of claim 55, wherein the wood substrate comprises at least one hardwood.

60. The wood article of claim 59, wherein the at least one hardwood is selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; maple; mahogany; oak; olive; persea; plum; purpleheart; rosewood; sassafras; sidder; sycamore; storax; sweet gum; tamarisk; teak; tulipwood; walnut; willow; popular; and combinations thereof.

61. The wood article of claim 55, wherein the wood substrate comprises at least one softwood.

62. The wood article of claim 61, wherein the at least one softwood is selected from the group consisting of cedar; cyprus; juniper; savin; hemlock; western; fir; larch; pine; redwood; spruce; yew; and combinations thereof.

63. The wood article of claim 55, wherein the wood substrate comprises a primed wood.

64. The wood article of claim 63, whereby the primed wood is primed using an aqueous dispersion of an acid containing polymer.

65. The wood article of claim 64, wherein the acid containing polymer is ethylene (meth)acrylic acid copolymer.

66. The wood article of claim 65, wherein the ethylene (meth)acrylic acid copolymer comprises from about 10 wt % to about 30 wt % polymer units derived from the acid monomers.

67. The wood article of claim 55, wherein the wood substrate comprises burl wood, face burl wood, wormed wood, blackened wood, or combinations thereof.

68. The wood article of claim 55, wherein the ionomer layer comprises a first ionomer layer and a second ionomer layer.

69. The wood article of claim 68, wherein the first ionomer layer or the second ionomer layer is pigmented, natural, or clear.

70. The wood article of claim 55, wherein the ionomer layer is transparent.

71. The wood article of claim 55, wherein the wood article further comprises a tie-layer.

72. The wood article of claim 71, wherein the tie-layer comprises a copolymer of a C₂ to C₁₀ alpha-olefin copolymerized with an alkyl (meth)acrylate.

73. The wood article of claim 71, wherein the tie-layer comprises a terpolymer of a C₂ to C₁₀ alpha-olefin copolymerized with an alkyl 140 (meth)acrylate and an acidic monomer.

74. The wood article of claim 73, wherein the acidic monomer is (meth)acrylic acid.

75. The wood article of claim 71, wherein the tie-layer comprises an epoxy containing polymer.

76. The wood article of claim 71, wherein the tie-layer comprises an ethylene (meth)acrylic acid copolymer or a blend of an ethylene (meth)acrylic acid copolymer with a polyolefin and/or an acid terpolymer.

77. The wood article of claim 71, wherein the tie-layer comprises an alkyl(meth)acrylate ester copolymer or a blend of an alkyl(meth)acrylate ester copolymer with a polyolefin and/or an acid copolymer or terpolymer.

78. The wood article of claim 55, wherein the wood article further comprises a plurality of valves or perforations.

79. The wood article of claim 55, wherein the ionomer layer has a uniform ionomer layer thickness.

80. The wood article of claim 55, wherein the ionomer layer has an ionomer layer thickness of 2.0 mm or less.

81. A wood article comprising:
a wood substrate; and
an ionomer layer;
wherein the ionomer layer has a uniform ionomer layer thickness.

82. The wood article of claim 81, wherein the wood substrate comprises natural wood, pressure treated wood, laminated wood, or combinations thereof.

83. The wood article of claim 81, wherein the wood substrate comprises select lumber.

84. The wood article of claim 81, wherein the wood substrate comprises common lumber.

85. The wood article of claim 81, wherein the wood substrate comprises at least one hardwood.

86. The wood article of claim 85, wherein the at least one hardwood is selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; maple; mahogany; oak; olive; persea; plum; purpleheart; rosewood; sassafras; sidder; sycamore; storax; sweet gum; tamarisk; teak; tulipwood; walnut; willow; popular; and combinations thereof.

87. The wood article of claim 81, wherein the wood substrate comprises at least one softwood.

88. The wood article of claim 87, wherein the at least one softwood is selected from the group consisting of cedar; cyprus; juniper; savin; hemlock; western; fir; larch; pine; redwood; spruce; yew; and combinations thereof.

89. The wood article of claim 81, wherein the wood substrate comprises a primed wood.

90. The wood article of claim 89, whereby the primed wood is primed using an aqueous dispersion of an acid containing polymer.

91. The wood article of claim 90, wherein the acid containing polymer is ethylene (meth)acrylic acid copolymer.

92. The wood article of claim 91, wherein the ethylene (meth)acrylic acid copolymer comprises from about 10 wt % to about 30 wt % polymer units derived from the acid monomers.

93. The wood article of claim 81, wherein the wood substrate comprises burl wood, face burl wood, wormed wood, blackened wood, or combinations thereof.

94. The wood article of claim 81, wherein the ionomer layer comprises a first ionomer layer and a second ionomer layer.

95. The wood article of claim 94, wherein the first ionomer layer or the second ionomer layer is pigmented, natural, or clear.

96. The wood article of claim 81, wherein the ionomer layer is transparent.

97. The wood article of claim 81, wherein the wood article further comprises a tie-layer.

98. The wood article of claim 97, wherein the tie-layer comprises a copolymer of a C₂ to C₁₀ alpha-olefin copolymerized with an alkyl (meth)acrylate.

99. The wood article of claim 97, wherein the tie-layer comprises a terpolymer of a C₂ to C₁₀ alpha-olefin copolymerized with an alkyl (meth)acrylate and an acidic monomer.

100. The wood article of claim 99, wherein the acidic monomer is (meth)acrylic acid.

101. The wood article of claim 97, wherein the tie-layer comprises an epoxy containing polymer.

102. The wood article of claim 97, wherein the tie-layer comprises an ethylene (meth)acrylic acid copolymer or a blend of an ethylene (meth)acrylic acid copolymer with a polyolefin and/or an acid terpolymer.

103. The wood article of claim 97, wherein the tie-layer comprises an alkyl(meth)acrylate ester copolymer or a blend of an alkyl(meth)acrylate ester copolymer with a polyolefin and/or an acid copolymer or terpolymer.

104. The wood article of claim 81, wherein the wood article further comprises a plurality of valves or perforations.

105. The wood article of claim 81, wherein the wood article has an essentially uniform cross section.

106. The wood article of claim 81, wherein the ionomer layer has an ionomer layer thickness of 2.0 mm or less.

107. A method of forming a wood article comprising the steps of:
selecting a wood substrate;
introducing the wood substrate along its longitudinal axis into a crashed die, the crashed die mounted on a plastic extrusion machine;
subjecting said wood substrate to a vacuum;
extruding an ionomer layer on the wood substrate; and
forming a wood article.

108. The method of claim 107, wherein the wood substrate comprises natural wood, pressure treated wood, laminated wood, or combinations thereof.

109. The method of claim 107, wherein the wood substrate comprises select lumber.

110. The method of claim 107, wherein the wood substrate comprises common lumber.

111. The method of claim 107, wherein the wood substrate comprises at least one hardwood.

112. The method of claim 111, wherein the at least one hardwood is selected from the group consisting of acacia; alder; almond; ash; aspen; African black; balsa; basswood; beech; birch; boxwood; brazilwood; bubinga; buckeye; butternut; buttonwood; carbob; cherry; chestnut; Christ's thorn; cocobolo; common box; cork wood; cottonwood; date palm; dom/doum palm; ebony; elm; hackberry; hickory; hornbeam; iron wood; jelutong; kingwood; lime; linden; locust; maple; mahogany; oak; olive; persea; plum; purpleheart; rosewood; sassafras; sidder; sycamore; storax; sweet gum; tamarisk; teak; tulipwood; walnut; willow; popular; and combinations thereof.

113. The method of claim 107, wherein the wood substrate comprises at least one softwood.

114. The method of claim 113, wherein the at least one softwood is selected from the group consisting of cedar; cyprus; juniper; savin; hemlock; western; fir; larch; pine; redwood; spruce; yew; and combinations thereof.

115. The method of claim 107, wherein the wood substrate comprises a primed wood.

116. The method of claim 115, whereby the primed wood is primed using an aqueous dispersion of an acid containing polymer.

117. The method of claim 116, wherein the acid containing polymer is ethylene (meth)acrylic acid copolymer.

118. The method of claim 117, wherein the ethylene (meth)acrylic acid copolymer comprises from about 10 wt % to about 30 wt % polymer units derived from the acid monomers.

119. The method of claim 107, wherein the wood substrate comprises burl wood, face burl wood, wormed wood, blackened wood, or combinations thereof.

120. The method of claim 107, wherein the ionomer layer comprises a first ionomer layer and a second ionomer layer.

121. The method of claim 120, wherein the first ionomer layer or the second ionomer layer is pigmented, natural, or clear.

122. The method of claim 107, wherein the ionomer layer is transparent.

123. The method of claim 107, wherein the wood article further comprises a tie-layer.

124. The method of claim 123, wherein the tie-layer comprises a copolymer of a C₂ to C₁₀ alpha-olefin copolymerized with an alkyl (meth)acrylate.

125. The method of claim 123, wherein the tie-layer comprises a terpolymer of a C₂ to C₁₀ alpha-olefin copolymerized with an alkyl (meth)acrylate and an acidic monomer.

126. The method of claim 125, wherein the acidic monomer is (meth)acrylic acid.

127. The method of claim 123, wherein the tie-layer comprises an epoxy containing polymer.

128. The method of claim 123, wherein the tie-layer comprises an ethylene (meth)acrylic acid copolymer or a blend of an ethylene (meth)acrylic acid copolymer with a polyolefin and/or an acid terpolymer.

129. The method of claim 123, wherein the tie-layer comprises an alkyl(meth)acrylate ester copolymer or a blend of an alkyl(meth)acrylate ester copolymer with a polyolefin and/or an acid copolymer or terpolymer.

130. The method of claim 107, wherein the wood article further comprises a plurality of valves or perforations.

131. The method of claim 107, wherein the wood article has an essentially uniform cross section.

132. The method of claim 107, wherein the ionomer layer has a uniform ionomer layer thickness.

133. The method of claim 107, wherein the ionomer layer has an ionomer layer thickness of 2.0 mm or less.

134. A method to produce a wood article comprising the steps of obtaining a wood substrate and crosshead extruding the wood substrate with an ionomer layer to form the wood article.

135. An article produced by the method of claim 134.
